(19) United States
(12) Patent Application Publication
(10) Pub. No.: US 2025/0053934 A1
(43) Pub. Date: Feb. 13, 2025

(54) DAY-AHEAD COORDINATED OPTIMIZATION SCHEDULING METHOD FOR TRUNK MOBILE CHARGING STATION

(71) Applicant: Tianjin University, Tianjin (CN)

(72) Inventors: Hongjie JIA, Tianjin (CN); Kecheng HE, Tianjin (CN); Yunfei MU, Tianjin (CN); Xiaodan YU, Tianjin (CN); Xiandong XU, Tianjin (CN); Xiaohong DONG, Tianjin (CN)

(73) Assignee: Tianjin University, Tianjin (CN)

(21) Appl. No.: 18/786,207

(22) Filed: Jul. 26, 2024

(30) Foreign Application Priority Data
Jul. 28, 2023 (CN) 202310938963.5

(51) Int. Cl. G06Q 10/1093; B60L 53/57; B60L 53/62; G06Q 30/0202; H02J 3/00

(52) U.S. Cl. CPC G06Q 10/1095; B60L 53/57; B60L 53/62; G06Q 30/0202; H02J 3/003; H02J 2203/20

(57) ABSTRACT

The present disclosure relates to the technical field of optimization of charging facilities, and in particular, to a day-ahead coordinated optimization scheduling method for a truck mobile charging station. The method includes: constructing an optimization scheduling model framework, wherein the optimization scheduling model framework includes: an EV charging demand generation model and a TMCS spatial-temporal model, the EV model is used to determine the position and time of the TMCS charging demand, and the TMCS scheduling model is used to describe the spatial-temporal dynamic characteristics of TMCS operation and complete the coordinated optimization scheduling of TMCS between EV charging service and energy arbitrage; capturing a charging decision process of heterogeneous EV users by adopting MCS and a multinomial Logit model; establishing an extended graph model to describe the spatial-temporal dynamic characteristics of TMCS; and then expressing the coordinated scheduling model as a mixed integer linear programming model.

### CROSS-REFERENCE TO RELATED APPLICATIONS

This application claims priority to Chinese Patent Application No. 202310938963.5 with a filing date of Jul. 28, 2023. The content of the aforementioned application, including any intervening amendments thereto, is incorporated herein by reference.

### TECHNICAL FIELD

The present disclosure relates to a day-ahead coordinated optimization scheduling method for a truck mobile charging station, and belongs to the technical field of optimization of charging facilities.

### BACKGROUND

The carbon dioxide produced by the transportation sector accounts for about one quarter of the global carbon emissions. The electrification of transportation and the construction of charging infrastructure, as an important means of reducing carbon emissions in the transportation industry, have great significance for ensuring the smooth realization of “carbon peaking” and “carbon neutrality” goals in China. In recent years, many documents in China have pointed out that the construction of electric vehicles (EVs) and charging infrastructures is strongly promoted. According to the latest statistics, the number of charging piles in China increased by nearly 100% year-on-year in 2022. However, conventional fixed charging stations (FCSs) currently still face challenges such as high expansion costs, long construction periods, and lack of flexibility. In 2022, documents are jointly printed by multiple departments in China, a charging network layout of “fixed as the main and mobile as the auxiliary” is required to be formed by the end of 2025 in areas such as highways, and a mobile charging facility is required to meet the charging requirements during peak hours.

A mobile charging station (TMCS) integrates a certain number of charging piles and energy storage battery packs in a container loaded by a truck. Since the TMCS is independent of a grid, the TMCS is easier to expand than an FCS and can provide on-demand charging services for EVs in any area. Liu et al. studies the vehicle-routing of a smaller portable charging station (PCS). Similarly, scholars have studied the application of PCS in shared electric vehicle charging and mobile on-the-go charging. Peng et al. studies PCS routing, fleet size, and depot location. Afshar et al. introduces different types of FCSs and PCSs to minimize the overall charging cost and time for EV users. Liu et al. adopts a joint learning method to help idle PCSs predict possible charging positions and move to these locations in advance. These studies provide references for the scheduling of TMCS. However, the TMCS is mainly used to assist FCS operation due to its large capacity rather than providing scheduled charging services for individual EVs. Wang et al. optimizes the service position of TMCS using a flow-based refueling location model. Moghadam et al. reduces the peak load rate of FCS by scheduling TMCS to the charging peak area, but approximates the charging demand of TMCS to a change in traffic flow. Chen et al. and Ejaz et al. discuss the optimal scheduling method for TMCS based on the Internet of Things. However, all of the above studies ignore the selection process of EV users between various charging solutions such as FCS and TMCS. Charkraborty et al. proposes a cloud-based control framework and decision process to reduce the charging time of EVs by introducing TMCS and using on-the-go charging. In addition, some studies have also focused on the application of TMCS in EV parking lots and socially equitable access, as well as auction-based energy trading strategies between EVs and TMCS. However, the above studies only consider the scenario where TMCS participates in EV charging service. During non-charging periods, TMCS is idle, which is not conducive to the utilization and economy of TMCS and fails to fully exploit the flexibility potential of the TMCS.

### SUMMARY

Aiming at the defects in the existing technology, the present disclosure provides a day-ahead coordinated optimization scheduling method for a TMCS, which improves the utilization rate of TMCS and the profitability of operators, can effectively obtain the spatial-temporal distribution of the FCS and the TMCS charging demand, and completes day-ahead coordinated optimization scheduling of TMCS operation between EV charging service and energy arbitrage.

A technical solution of the present disclosure for resolving the above technical problems is as follows: a day-ahead coordinated optimization scheduling method for TMCS, including:
S1: constructing an EV model, and generating spatial-temporal distribution of EV charging demands for FCS and TMCS by using the EV model according to traffic flow prediction data and the configuration information of the FCS and the TMCS; and
S2: constructing a TMCS scheduling model, wherein the TMCS scheduling model describes spatial-temporal dynamic characteristics of TMCS operation and completes coordinated optimization scheduling of TMCS between EV charging service and energy arbitrage, and establishing a day-ahead optimization scheduling method for TMCS to maximize the profitability of a charging facility operator (CFO).

Further, in the step S1, the market share and energy consumption characteristics of different types of EVs are obtained according to market sales data, wherein the energy consumption characteristics of EVs include battery capacity and probability distribution of energy consumption per unit mileage;
a departure time and a probability density function of initial values of state of charge (SOC) of the EVs under unified confidence are obtained by fitting the EV charging data;
start and end points of the EV are generated by an origin-destination (OD) analysis method, and a travel path is obtained based on Monte Carlo simulation (MCS) and a Floyd algorithm [19]; and
EVi needs to be charged on the way, and potential charging selection solutions are generated according to road and travel limits, SOC data and charging station positions, wherein a set of the charging selection solutions is denoted as Sᵢ, Sᵢ includes J solutions, and EVi is an i^{th} electric vehicle.

Further, the EV model is as follows:
a charging capacity when EVi selects the charging solution j is shown in formula (1):

$${ℳ}_{i}^{m , j} = \{ \begin{matrix}\text{?} ( \text{?} + \text{?} - \text{?} ) , & if 0 < \text{?} ( \text{?} + \text{?} - \text{?} ) / \text{?} \leq 0.9 \\ \text{?} , & if \text{?} ( \text{?} + \text{?} - \text{?} ) / \text{?} > 0.9\end{matrix} \qquad ( 1 )$$

$$\text{?} \text{indicates text missing or illegible when filed}$$

wherein [symbol] is the charging capacity of the EVi when the solution j is selected at a road network node m, [symbol] ₜᵢ is a battery energy efficiency coefficient, Cₑᵢ is the energy consumption per unit mileage of the EVi, dᵢ is the remaining mileage of the EVi, dᵢ^{re} is the remaining available mileage of the EVi based on user preference, dᵢ^{m} is the mileage when the EVi reaches the node m, [symbol] is a rated capacity of a battery of the EVi, [symbol] is the charging capacity of the EVi obtained by MCS sampling, and dᵢ^{re} and [symbol] satisfies truncated normal distribution;
the cost when EVi selects the charging solution j is the sum of charging cost and time cost, as shown in formula (2):

$${c}_{i} ( j ) = {α}_{m}^{j} {ℳ}_{i}^{m , j} + {INC}_{i} ( {W}_{q}^{j , t} + {ℳ}_{i}^{m , j} / {η}_{dch} {P}_{r}^{j} + {s}_{c} ) / {T}_{m} \qquad ( 2 )$$

wherein cᵢ(j) is the total cost when EVi selects the solution j, αₘ^{j} is the charging fee per kWh of the solution j; INCᵢ is the monthly income of the user, W_{q}^{j,t} is the queuing time of the solution j at time t determined by the M/M/c/∞/∞ queuing theory, η_{dch} is the charging efficiency, Pᵣ^{j} is the rated power of a charging pile, S_{c} is the operation time, and Tₘ is the average monthly working time of the user;
the probability of EVi selecting the solution j is shown in formula (3), and the TMCS charging demand at node m at time t is generated by formula (4);

$${𝒫}_{i} ( j ) = exp ( {c}_{i} ( j ) ) / {\sum }_{j}^{J} exp ( {c}_{i} ( j ) ) \qquad ( 3 )$$

$${P}_{m}^{t} = {\sum }_{i} {ℳ}_{i}^{m , j} , i ∈ {χ}_{t , m}^{tmc} \qquad ( 4 )$$

wherein [symbol] ᵢ(j) is the probability that a driver chooses charging scheme j, Pₘ^{t} is the hourly EV charging demand of TMCS at node m, and χ_{t,m}^{tmc} is the set of EVs choose TMCS for charging; the simulation ends when the convergence condition of formula (5) is met, and the spatial-temporal distribution of the EV charging demand is obtained:

$$max [ \vert ( {\sum }_{π = 1}^{\prod } {P}_{m , π}^{t} - {\sum }_{π = \prod }^{2 \prod } {P}_{m , π}^{t} ) / \prod \vert ] \leq ε \qquad ( 5 )$$

wherein P_{m,π}^{t} is the hourly EV charging demand at node m after a π^{th} iteration, Π is a predefined number, and ε is the convergence coefficient.

Further, in the step S2, a set M of TMCS operation positions is divided into two disjoint subsets, M_{c} and Mₐ, wherein M_{c} represents a set of charging service nodes, Mₐ represents a set of arbitrage nodes, and a virtual arc represented by the TMCS start and end points describes the dynamic operation state of the TMCS, so as to obtain the spatial-temporal distribution characteristics of the TMCS; and
the virtual arc is divided into a transit arc and a parking arc, the transit arc is composed of two nodes and connecting arcs, the transit arc represents a feasible transit route, the transit arc has a directionality and is divided into a charging transit arc Z_{c}, an arbitrage transit arc Zₐ and a transfer arc Zₑ according to node types, and the parking arc represents that TMCS stops at a certain node for at least one time period.

Further, the TMCS scheduling model is as follows:

$$\text{?} + \text{?} {ζ}_{ω , nv}^{t} + \text{?} {ζ}_{ω , mn}^{t} = 1 , ∀ ω ∈ Ω , t ∈ T \qquad ( 6 )$$

$$\text{?} + \text{?} \geq \text{?} - \text{?} , ∀ ω ∈ Ω , m ∈ {M}_{c} , n ∈ {M}_{a} , t ∈ T \qquad ( 7 )$$

$$\text{?} + \text{?} \geq \text{?} - \text{?} , ∀ ω ∈ Ω , m ∈ {M}_{c} , n ∈ {M}_{a} , t ∈ T \qquad ( 8 )$$

$$\text{?} + \text{?} = \text{?} + \text{?} , ∀ ω ∈ Ω , m ∈ {M}_{c} , n ∈ {M}_{a} , t ∈ T \qquad ( 9 )$$

$$\text{?} + \text{?} = \text{?} + \text{?} , ∀ ω ∈ Ω , m ∈ {M}_{c} , n ∈ {M}_{a} , t ∈ T \qquad ( 10 )$$

$$\text{?} + \text{?} = \text{?} , ∀ ω ∈ Ω , m ∈ {M}_{c} , n ∈ {M}_{a} \qquad ( 11 )$$

$$\text{?} + \text{?} = \text{?} , ∀ ω ∈ Ω , m ∈ {M}_{c} , n ∈ {M}_{a} \qquad ( 12 )$$

$$\text{?} + \text{?} \leq 1 , ∀ ( m , u ) ∈ {Z}_{c} , m \neq u , t ∈ T \qquad ( 13 )$$

$$\text{?} + \text{?} \leq 1 , ∀ ( n , v ) ∈ {Z}_{a} , n \neq v , t ∈ T \qquad ( 14 )$$

$$\text{?} + \text{?} \leq 1 , ∀ ( m , n ) ∈ {Z}_{e} , m \neq n , t ∈ T \qquad ( 15 )$$

$$\text{?} \text{indicates text missing or illegible when filed}$$

wherein ω is the number of TMCS, Ω is the set of TMCS, T is the set of hourly periods t, m and u are road network charging service nodes, n and v are energy arbitrage nodes, ζ_{ω,mu}^{t}, ζ_{ω,nv}^{t}, ζ_{ω,mn}^{t}, ζ_{ω,mm}^{t}, ζ_{ω,nn}^{t}, ζ_{ω,um}^{t}, ζ_{ω,nm}^{t}, ζ_{ω,vn}^{t}, ζ_{ω,mm}^{t+1}, ζ_{ω,nn}^{t+1}, ζ_{ω,mu}^{t+1}, ζ_{ω,mm}^{t+1}, ζ_{ω,nv}^{t+1}, ζ_{ω,nv}^{t}^{ₑ}⁺¹, ζ_{ω,nm}^{t+1}, ζ_{ω,nm}^{t}^{ₑ}⁺¹, ζ_{ω,nn}^{t}^{ₑ}, ζ_{ω,vn}^{t}^{ₑ}⁻¹, ζ_{ω,mn}^{t}^{ₑ}⁺¹, ζ_{ω,um}^{t+1}, ζ_{ω,vn}^{t+1}, ζ_{ω,nm}^{t+1} are binary variables, which represent whether the TMCS numbered w is on the corresponding transit arc at the corresponding time;
when the TMCS ω is on the transit arc (m, u) at the time t, ζ_{ω,mu}^{t}=1, and when the TMCS ω is not on the transit arc (m, u), ζ_{ω,mu}^{t}=0, and the same is true for other binary variables; tₑ is the time for ending the work of the TMCS; and Z₊_{_{c}} represents a forward-direction charging arc, Z₋_{^{c}} represents a reverse-direction charging arc, Z₊_{ₐ} represents a forward-direction arbitrage arc, Z₋ₐ represents a reverse-direction arbitrage arc, Z₊_{ₑ} represents a forward-direction transfer arc, and Z₋ₑ represents a reverse-direction transfer arc.

Further, TMCS is required to satisfy the following operating constraints during charging and arbitrage operations:

$$0 \leq {P}_{ch , ω n}^{t} \leq {\sum }_{n ∈ {M}_{a}} {ζ}_{ω , nn}^{t} min ( {P}_{ch , ω}^{max} , {P}_{out , n}^{t , max} ) \qquad ( 16 )$$

$$0 \leq {P}_{ch , ω n}^{t} \leq {I}_{ch , ω}^{t} min ( {P}_{ch , ω}^{max} , {P}_{out , n}^{t , max} ) \qquad ( 17 )$$

$$\{ \begin{matrix}0 \leq {P}_{ch , ω n}^{t} \leq {\sum }_{n ∈ {M}_{a}} {ζ}_{ω , nn}^{t} min ( {P}_{dch , ω}^{max} , {P}_{inj , n}^{t , max} ) , & if {P}_{m}^{t} \leq {ρ}^{c} {P}_{cs , ω}^{max} \\ {P}_{dch , ω n}^{t} = 0 , & otherwise\end{matrix} \qquad ( 18 )$$

$$\{ \begin{matrix}0 \leq {P}_{ch , ω n}^{t} \leq {I}_{dch , ω}^{t} min ( {P}_{dch , ω}^{max} , {P}_{inj , n}^{t , max} ) , & if {P}_{m}^{t} \leq {ρ}^{c} {P}_{cs , ω}^{max} \\ {P}_{dch , ω n}^{t} = 0 , & otherwise\end{matrix} \qquad ( 19 )$$

$${I}_{ch , ω}^{t} + {I}_{dch , ω}^{t} \leq {\sum }_{n ∈ {M}_{a}} {ζ}_{ω , nn}^{t} \qquad ( 20 )$$

$${P}_{dch , ω m}^{t} = {ζ}_{ω , mm}^{t} min ( {P}_{m}^{t} , {P}_{cs , ω}^{max} ) \qquad ( 21 )$$

$${SOC}_{ω}^{t + 1} = {SOC}_{ω}^{t} - \frac{Δ T}{{E}_{ω}^{tmc}} \{ ( {\sum }_{n ∈ {M}_{a}} {P}_{dch , ω n}^{t + 1} + {\sum }_{m ∈ {M}_{c}} {P}_{dch , ω n}^{t + 1} ) / {η}_{dch , ω} - {η}_{ch , ω} {\sum }_{n ∈ {M}_{a}} {P}_{ch , ω n}^{t + 1} \} , ∀ ω ∈ Ω , t ∈ T \qquad ( 22 )$$

$${SOC}_{min} \leq {SOC}_{ω}^{t} \leq {SOC}_{max} , ∀ ω ∈ Ω , t ∈ T \qquad ( 23 )$$

wherein P^{t ch,ωn} is the charging power of TMCS ω to the node n at time t, P^{t dch,ωn} is the discharging power of TMCS ω to the node n at time t. P_{ch,ωn}^{t+1} is the charging power of TMCS ω to the node n at time t+1, and P_{dch,ωn}^{t+1} is the discharging power of TMCS ω to the node n at time t+1; P_{ch,ωn}^{max} is the maximum charging power of TMCS ω, P_{dch,ω}^{max} is the maximum discharging power of TMCS ω; P_{out,n}^{t,max} is the maximum outflow power of the node n at the time t determined by the network limitation of a distribution network, and P_{inj,n}^{t,max} is the maximum injection power of the node n at the time t determined by the network limitation of the distribution network; P_{ch,ω}^{max} is the maximum power of TMCS ω charging service; I^{t ch,ω} and I^{t dch,ω} are binary variables, when TMCS ω is charged at time t, I^{t ch,ω}=1, when TMCS ω is not charged at time t, I^{t ch,ω}=0, when TMCS ω is discharged at time t, I^{t dch,ω}=1, when TMCS ω is not discharged at time t, I^{t dch,ω}=0; E_{ω}^{tmc} is the capacity of TMCS; ρ^{c} represents the charging demand satisfaction rate of the electric vehicle, which reflects the preference of CFO on the charging service quality; η_{ch,ω} is the charging efficiency of TMCS, [symbol] is the discharging efficiency of TMCS; SOC_{ω}^{t} is the SOC of TMCS ω at the end of time t, SOCₘₐₓ is the maximum SOC value of TMCS, and SOCₘᵢₙ is the minimum SOC value of TMCS.

Further, a calculation method to maximize the profitability of CFO is as follows: [symbol] f(xₗ)=R(xₗ)−C^{OM}(xₗ)−C^{DEG}(xₗ), where xₜ=[P_{dch,ωm}^{t}, P_{dch,ωn}^{t}, P_{ch,ωn}^{t},

$${x}_{t} = [ {P}_{dch , ω m}^{t} , {P}_{dch , ω n}^{t} , {P}_{ch , ω n}^{t} , {ζ}_{ω , nv}^{t} , {ζ}_{ω , mu}^{t} , \\ {ζ}_{ω , mn}^{t} , {I}_{ch , ω}^{t} , {I}_{dch , ω}^{t} ∀ ω ∈ Ω , \{ m , u \} ∈ {M}_{c} , \{ n , v \} ∈ {M}_{a} , t ∈ T ] \qquad ( 24 )$$

$$R ( {x}_{t} ) = {\sum }_{t ∈ T} {\sum }_{ω ∈ Ω} ( {α}_{m}^{tmc} {P}_{dch , ω m}^{t} + {λ}_{n}^{t} {P}_{dch , ω n}^{t} - {λ}_{n}^{t} {P}_{ch , ω n}^{t} ) \qquad ( 25 )$$

$${C}^{OM} ( {x}_{t} ) = {\sum }_{ω ∈ Ω} ( {λ}_{n}^{0} {c}_{e}^{tmc} {d}_{mn , ω} + {c}^{LA} + {c}^{MT} ) \qquad ( 26 )$$

$${C}^{DEG} ( {x}_{t} ) = {c}^{MDC} \{ {q}_{t} + {\sum }_{t ∈ T} {\sum }_{ω ∈ Ω} ( {P}_{dch , ω m}^{t} + {P}_{dch , ω n}^{t} + {P}_{ch , ω n}^{t} ) \} / {( 1 + {r}_{0} )}^{- κ ( t )} \qquad ( 27 )$$

$$s . t . ( 6 ) - ( 15 ) , ( 16 - 23 ) \qquad ( 28 )$$

wherein [symbol] is the maximization of the profitability of CFO, R(xₜ) is daily operating revenue, C^{OM}(xₜ) is the daily operating and maintenance cost, and C^{DEG}(xₜ) is the daily battery degradation cost; and
the vector xₜ is a decision variable, λₙ^{t} is the time-of-use electricity price of the node n, λ⁰ₙ is the electricity price when the TMCS returns to a depot for charging after the service ends, cₑ^{tmc} is the energy consumption per kilometer of TMCS, d_{mn,ω} is the total travel of TMCS in one day, αₘ^{tmc} is the charging service fee of TMCS, c^{LA} is the daily labor cost, c^{MT} is the daily maintenance cost, c^{MDC} is the marginal degradation cost of the TMCS life cycle, qₜ is the calendar degradation parameter of the TMCS battery pack, r₀ is the discount rate; and κ(t) is the year number corresponding to the time t when the TMCS is put into use.

The day-ahead coordinated optimization scheduling method for the TMCS of the present disclosure includes: constructing an optimization scheduling model framework, where the optimization scheduling model framework includes: an EV charging demand generation model (namely, EV model) and a TMCS spatial-temporal scheduling model (namely, TMCS scheduling model), the EV model is used to determine a position and time of the TMCS charging demand, and the TMCS scheduling model is used to describe the spatial-temporal dynamic characteristics of TMCS operation and complete the coordinated optimization scheduling of TMCS between EV charging service and energy arbitrage; capturing a charging decision process of heterogeneous EV users by adopting Monte Carlo simulation (MCS) and a multinomial Logit (MNL) model; establishing an extended graph model to describe the spatial-temporal dynamic characteristics of TMCS; and then expressing the coordinated scheduling model as a mixed integer linear programming (MILP) model. The beneficial effects provided are as follows:

(1) The present disclosure provides a day-ahead optimization scheduling framework for TMCS to coordinate the coordinated operation of the TMCS between EV charging service and energy arbitrage, so that the spatial-temporal distribution of the EV charging demand for TMCS can be effectively obtained, and day-ahead coordinated optimization scheduling of TMCS operation between EV charging service and energy arbitrage is completed.

(2) The scheduling method provided by the present disclosure explores the feasibility of TMCS operation in various business modes, and can effectively improve the utilization rate of TMCS and the profitability of operators.

(3) The scheduling method provided by the present disclosure captures the charging decision process of heterogeneous EV users between various charging solution such as FCS and TMCS.

(4) The present disclosure accurately describes the spatial-temporal dynamic characteristics of TMCS, enhances the flexibility of the charging facilities, and provides a new solution for the rapid expansion of the charging facilities.

### BRIEF DESCRIPTION OF DRAWINGS

FIG. 1 is an architecture diagram of a day-ahead coordinated optimization scheduling method for a mobile charging station;

FIG. 2 is an extended graph model of TMCS operation;

FIG. 3 is a flowchart of a day-ahead coordinated optimization scheduling method for a mobile charging station;

FIG. 4 shows a distribution of positions of a ring highway network and related nodes;

FIG. 5 shows a distribution of EV departure times;

FIG. 6 shows a road network OD matrix;

FIG. 7 shows a scheduling optimization result of TMCS in Scenario 1 (TMCS 1, Case 1);

FIG. 8 shows a scheduling optimization result of TMCS in Scenario 1 (TMCS 1, Case 2);

FIG. 9 shows a scheduling optimization result of TMCS in Scenario 1 (TMCS 2, Case 1);

FIG. 10 shows a scheduling optimization result of TMCS in Scenario 1 (TMCS 2, Case 2);

FIG. 11 shows SOC values of TMCSs in Scenario 1 (Case 1);

FIG. 12 shows SOC values of TMCSs in Scenario 1 (Case 2);

FIG. 13 shows a scheduling optimization result of Case 1 and Case 2 in Scenario 2 (TMCS 1);

FIG. 14 shows a scheduling optimization result of Case 1 and Case 2 in Scenario 2 (TMCS 2);

FIG. 15 shows a scheduling optimization result of Case 1 and Case 2 in Scenario 2 (TMCS 3);

FIG. 16 shows a scheduling optimization result of Case 1 and Case 2 in Scenario 2 (TMCS 4);

FIG. 17 shows SOC values of TMCSs of Case 1 and Case 2 in Scenario 2; and

FIG. 18 shows charging demands and responses of stations under Scenario 2, where (a) EV charging demand of TMCS, and (b) EV charging load satisfied by TMCS.

### DETAILED DESCRIPTION

The specific embodiments of the present disclosure are described in detail below. The present disclosure can be implemented in many other manners different from those described herein. Those skilled in the art may make similar improvements without departing from the spirit of the present disclosure. Therefore, the present disclosure is not limited by the specific embodiments disclosed.

Unless otherwise defined, all technical and scientific terms used in this specification have the same meanings as would be generally understood by those skilled in the art of the present disclosure. The term used is for the purpose of describing particular embodiments only and is not intended to be limiting of the present disclosure.

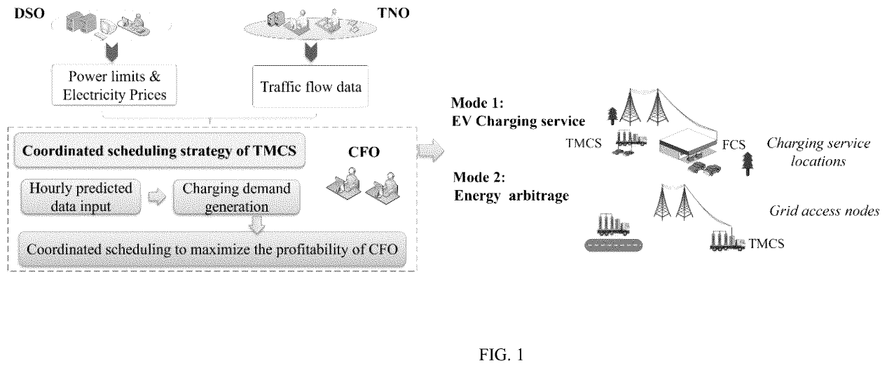

The optimization model framework designed by the present disclosure is shown in FIG. 1, wherein DSO, TSO and CFO represent a distribution system operator, a traffic system operator and a charging facility operator, respectively. CFO operates with a certain number of FCSs and TMCSs. The spatial-temporal distribution of the EV charging demands for the FCS and the TMCS is generated by adopting an EV model according to the traffic flow prediction data and the configuration information of the FCS and the TMCS. The power limits and electricity prices of nodes in the distribution network are obtained according to the day-ahead operation plan of a grid. Then, the day-ahead optimization scheduling method for TMCS is formulated based on the maximization of the profitability of CFO.

### I. EV Model

The spatial-temporal distribution of TMCS charging demand is mainly influenced by battery capacity, travel plans, road network constraints and user charging decision behavior. The market share and energy consumption characteristics of different types of EVs are obtained according to market sales data, namely the probability distribution of battery capacity (mᵣ) and energy consumption per unit mileage (Cₑ); a departure time and a probability density function of initial values of SOC of the EVs under unified confidence are obtained by fitting EV charging. Further, start and end points of the EV are generated by an OD analysis method, and a travel path is obtained based on Monte Carlo simulation and a Floyd algorithm [19]. If EVi needs to be charged on the way, potential charging selection solutions are generated according to road and travel limits, SOC data and charging station positions. The set of the charging selection solutions is denoted as Sᵢ (a total of J solutions), which contains TMCS or FCS located at network node m. Further, a charging capacity when EVi selects the charging solution j is shown in formula (1).

$${ℳ}_{i}^{m , j} = \{ \begin{matrix}η \text{?} 𝒞 \text{?} ( {d}_{i} + {d}_{i}^{re} - {d}_{i}^{m} ) , & if 0 < η \text{?} 𝒞 \text{?} ( {d}_{i} + d \text{?} - {d}_{i}^{m} ) / ℳ \text{?} \leq 0.9 \\ {𝕄}_{i}^{m , j} , & if η \text{?} 𝒞 \text{?} ( {d}_{i} + {d}_{i}^{re} - {d}_{i}^{m} ) / ℳ \text{?} > 0.9\end{matrix} \qquad ( 1 )$$

$$\text{?} \text{indicates text missing or illegible when filed}$$

wherein [symbol] is the charging capacity of the EVi when the solution j is selected at a road network node m, [symbol] is a battery energy efficiency coefficient, Cₑᵢ is the energy consumption per unit mileage of the EVi, dᵢ is the remaining mileage of the EVi, dᵢ^{re} is the remaining available mileage of the EVi based on user preference, dᵢ^{m} is the mileage when the EVi reaches the node m, [symbol] is a rated capacity of a battery of the EVi, [symbol] is the charging capacity of the EVi obtained by MCS sampling, and dᵢ^{re} and [symbol] satisfies truncated normal distribution. In addition, according to reference [18], the arrival time of EVi is obtained based on a speed-flow model and a BPR function.

The user is mainly concerned about charging cost and charging waiting time when making charging decisions. The MNL model is a discrete selection model constructed for unordered multi-classification variables, and the selection behavior of the user facing different charging solutions is simulated by adopting the multinomial Logit theory. The cost when EVi selects the charging solution j is the sum of charging cost and time cost, as shown in formula (2).

$${c}_{i} ( j ) = {α}_{m}^{j} {ℳ}_{i}^{m , j} + {INC}_{i} ( {W}_{q}^{j , t} + {ℳ}_{i}^{m , j} / {η}_{dch} {P}_{r}^{j} + {s}_{c} ) / {T}_{m} \qquad ( 2 )$$

wherein cᵢ(j) is the total cost when EVi selects the solution j, αₘ^{j}, is the charging fee per kWh of the solution j; INCᵢ is the monthly income of the user, W_{q}^{j,t} is the queuing time of the solution j at time t determined by the M/M/c/∞/∞ queuing theory, η_{dch} is the charging efficiency, Pᵣ^{j} is the rated power of a charging pile, S_{c} is the operation time, and Tₘ is the average monthly working time of the user. In addition, according to reference [19], INCᵢ is generated by an improved income approach (IIA) model proposed in previous work to characterize the heterogeneity of EV users.

Further, the user i will weigh the utility of different charging solutions, which includes “gains” (savings in waiting time costs) or “losses” (increases in charging costs). The probability that a driver chooses the charging scheme j is shown in formula (3), and the TMCS charging demand at node m at time t is further generated by formula (4).

$${𝒫}_{i} ( j ) = exp ( {c}_{i} ( j ) ) / {\sum }_{j}^{J} exp ( {c}_{i} ( j ) ) \qquad ( 3 )$$

$${P}_{m}^{t} = {\sum }_{i} {ℳ}_{i}^{m , j} , i ∈ {χ}_{t , m}^{tmc} \qquad ( 4 )$$

wherein [symbol] ᵢ(j) is the probability that a driver chooses the charging scheme j, P^{t}ₘ is the hourly EV charging demand of TMCS at node m, and λ_{t,m}^{tmc} is the set of the EVs selecting TMCS charging; and based on the fixed point iteration method, when the convergence condition of formula (5) is satisfied, the simulation ends, and the spatial-temporal distribution of the EV charging demand is further obtained.

$$max [ \vert ( {\sum }_{π = 1}^{Π} {P}_{m , π}^{t} - {\sum }_{π = Π}^{2 Π} {P}_{m , π}^{t} ) / Π \vert ] \leq ε \qquad ( 5 )$$

wherein P_{m,π}^{t} is the hourly EV charging demand at node m after a π^{th} iteration, Π is a predefined number, and ε is the convergence coefficient. It is noted that the uncertainty in the prediction in the above process may affect the EV charging demand of TMCS, but does not affect the effectiveness of the scheduling method proposed by the present disclosure.

### II. TMCS Scheduling Model

In addition to assisting FCS in providing EV charging services, TMCS can also schedule to certain distribution network nodes during non-charging periods to participate in energy arbitrage and earn profits. Herein, a set M of TMCS operation positions is divided into two disjoint subsets, M_{c} and Mₐ, wherein M_{c} represents a set of charging service nodes, and Mₐ represents a set of arbitrage nodes. The present disclosure adopts a virtual arc represented by the TMCS start and end points to describe the dynamic operation state of the TMCS, so as to obtain the spatial-temporal distribution characteristics of the TMCS.

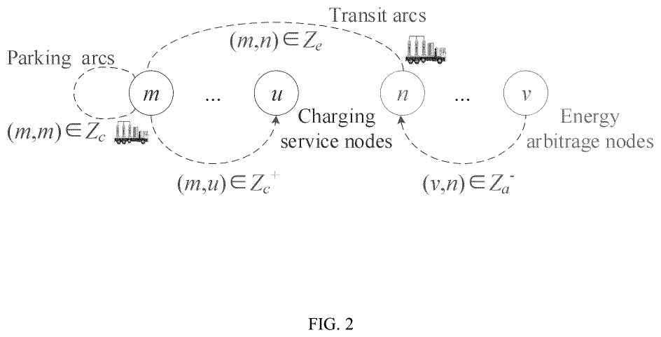

FIG. 2 is an extended graph model of TMCS operation, wherein the virtual arc is divided into a transit arc and a parking arc, the transit arc is composed of two nodes and connecting arcs, the transit arc represents a feasible transit route, the transit arc has a directionality and is divided into a charging transit arc Z_{c}, an arbitrage transit arc Zₐ and a transfer arc Zₑ according to node types, and the parking arc represents that TMCS stops at a certain node for at least one time period. According to the above definition, the scheduling model of TMCS is established as follows:

$$\text{?} {ζ}_{ω , mu}^{t} + \text{?} {ζ}_{ω , nv}^{t} + \text{?} {ζ}_{ω , mn}^{t} = 1 , \begin{matrix}∀ ω ∈ Ω , & t ∈ T\end{matrix} \qquad ( 6 )$$

$$\text{?} {ζ}_{ω , mu}^{t} + \text{?} {ζ}_{ω , mn}^{t} \geq {ζ}_{ω , mn}^{t + 1} - {ζ}_{ω , mn}^{t} , \qquad ( 7 )$$

$$∀ ω ∈ Ω , m ∈ {M}_{c} , n ∈ M \text{?} , t ∈ T$$

$$\text{?} {ζ}_{ω , nv}^{t} + \text{?} {ζ}_{ω , mn}^{t} \geq {ζ}_{ω , mn}^{t + 1} - {ζ}_{ω , mn}^{t} , \qquad ( 8 )$$

$$∀ ω ∈ Ω , m ∈ {M}_{c} , n ∈ M \text{?} , t ∈ T$$

$$\text{?} + \text{?} = \text{?} + \text{?} , ∀ ω ∈ Ω , m ∈ {M}_{c} , n ∈ M \text{?} , t ∈ T \qquad ( 9 )$$

$$\text{?} + \text{?} = \text{?} + \text{?} , \qquad ( 10 )$$

$$∀ ω ∈ Ω , m ∈ {M}_{c} , n ∈ M \text{?} , t ∈ T$$

$$\text{?} + \text{?} = \text{?} , \qquad ( 11 )$$

$$∀ ω ∈ Ω , m ∈ {M}_{c} , n ∈ M \text{?}$$

$$\text{?} + \text{?} = \text{?} , ∀ ω ∈ Ω , m ∈ {M}_{c} , n ∈ M \text{?} \qquad ( 12 )$$

$${ζ}_{ω , mu}^{t} + {ζ}_{ω , mu}^{t + 1} \leq 1 , ∀ ( m , u ) ∈ {Z}_{c} , m \neq u , t ∈ T \qquad ( 13 )$$

$${ζ}_{ω , mu}^{t} + {ζ}_{ω , mu}^{t + 1} \leq 1 , ∀ ( n , v ) ∈ {Z}_{a} , n \neq v , t ∈ T \qquad ( 14 )$$

$${ζ}_{ω , mu}^{t} + {ζ}_{ω , mu}^{t + 1} \leq 1 , ∀ ( m , n ) ∈ {Z}_{e} , m \neq n , t ∈ T \qquad ( 15 )$$

$$\text{?} \text{indicates text missing or illegible when filed}$$

wherein ω is the number of TMCS, ω is the set of TMCS, T is the set of hourly periods t, m and u are road network charging service nodes, n and v are energy arbitrage nodes, ζ_{ω,mu}^{t}, ζ_{ω,nv}^{t}, ζ_{ω,mn}^{t}, ζ_{ω,mm}^{t}, ζ_{ω,nn}^{t}, ζ_{ω,um}^{t}, ζ_{ω,nm}^{t}, ζ_{ω,vn}^{t}, ζ_{ω,mm}^{t+1}, ζ_{ω,nn}^{t+1}, ζ_{ω,mu}^{t+1}, ζ_{ω,mm}^{t+1}, ζ_{ω,nv}^{t+1}, ζ_{ω,nv}^{t}^{ₑ}⁺¹, ζ_{ω,nm}^{t+1}, ζ_{ω,nm}^{t}^{ₑ}⁺¹, ζ_{ω,nn}^{t}^{ₑ}, ζ_{ω,vn}^{t}^{ₑ}⁻¹, ζ_{ω,mn}^{t}^{ₑ}⁻¹, ζ_{ω,um}^{t+1}, ζ_{ω,vn}^{t+1}, ζ_{ω,nm}^{t+1}ζ_{ω,nm}^{t+1} are binary variables, which represent whether the TMCS numbered ω is on the corresponding transit arc at the corresponding time;
when the TMCS ω is on the transit arc (m, u) at the time t, ζ_{ω,mu}^{t}=1, and when the TMCS ω is not on the transit arc (m, u), ζ_{ω,mu}^{t}=0, and the same is true for other binary variables; tₑ is the time for ending the work of the TMCS; and
Z₊_{_{c}} represents a forward-direction charging arc, Z₋_{^{c}} represents a reverse-direction charging arc, Z₊_{ₐ}, represents a forward-direction arbitrage arc, Z₋_{^{a}} represents a reverse-direction arbitrage arc, Z₊_{ₑ} represents a forward-direction transfer arc, and Z₋ₑ represents a reverse-direction transfer arc.

The formula (6) ensures that TMCS ω is located on the transit arc or the parking arc. The constraints formula (7) and formula (8) represent the relationship between the transit arc and the parking arc. The constraints formula (9) and formula (10) represent that the TMCS that ends the travel at a node at time t will be located on an arc starting from this node at the next time. The formula (11) and formula (12) state the initial and final positions of TMCSs. The constraint formula (13) to formula (15) ensures that TMCS cannot make a round trip immediately. In addition, TMCS is required to satisfy the following operating constraints during charging and arbitrage operations:

$$0 \leq {P}_{ch , ω n}^{t} \leq {\sum }_{n ∈ {M}_{a}} {ζ}_{ω , nn}^{t} min ( {P}_{c h , ω}^{max} , {P}_{o u t , n}^{t , max} ) \qquad ( 16 )$$

$$0 \leq {P}_{ch , ω n}^{t} \leq {I}_{ch , ω}^{t} min ( {P}_{ch , ω}^{max} , {P}_{o u t , n}^{t , max} ) \qquad ( 17 )$$

$$\{ \begin{matrix}\begin{matrix}0 \leq {P}_{dch , ω n}^{t} \leq {\sum }_{n ∈ {M}_{a}} {ζ}_{ω , nn}^{t} min ( {P}_{dch , ω}^{max} , {P}_{inj , n}^{t , max} ) , & if {P}_{m}^{t} \leq {ρ}^{c} {P}_{cs , ω}^{max}\end{matrix} \\ \begin{matrix}{P}_{dch , ω n}^{t} = 0 , & otherwise\end{matrix}\end{matrix} \qquad ( 18 )$$

$$\{ \begin{matrix}\begin{matrix}0 \leq {P}_{dch , ω n}^{t} \leq {I}_{dch , ω}^{t} min ( {P}_{dch , ω}^{max} , {P}_{inj , n}^{t , max} ) , & if {P}_{m}^{t} \leq {ρ}^{c} {P}_{cs , ω}^{max}\end{matrix} \\ \begin{matrix}{P}_{dch , ω n}^{t} = 0 , & otherwise\end{matrix}\end{matrix} \qquad ( 19 )$$

$${I}_{c h , ω}^{t} + {I}_{d c h , ω}^{t} \leq {\sum }_{n ∈ {M}_{a}} {ζ}_{ω , nn}^{t} \qquad ( 20 )$$

$${P}_{dch , ω m}^{t} = {ζ}_{ω , m m}^{t} min ( {P}_{m}^{t} , {P}_{cs , ω}^{max} ) \qquad ( 21 )$$

$${SOC}_{ω}^{i + 1} = {SOC}_{ω}^{i} - \frac{Δ T}{{E}_{ω}^{\text{?}}} \{ ( {\sum }_{n ∈ {M}_{a}} {P}_{dch , ω n}^{i + 1} + {\sum }_{n ∈ {M}_{a}} {P}_{dch , ω m}^{i + 1} ) / {η}_{dch , ω} - {η}_{ch , ω} {\sum }_{n ∈ {M}_{a}} {P}_{ch , ω n}^{i + 1} \} , ∀ ω ∈ Ω , t ∈ T \qquad ( 22 )$$

$${SOC}_{min} \leq S O {C}_{ω}^{t} \leq {SOC}_{max} , ∀ ω ∈ Ω , t ∈ T \qquad ( 23 )$$

$$\text{?} \text{indicates text missing or illegible when filed}$$

wherein P_{ch,ωn}^{t+1} is the charging power of TMCS ω to the node n at time t, P_{dch,ωn}^{t} is the discharging power of TMCS ω to the node n at time t, P_{ch,ωn}^{t+1} is the charging power of TMCS ω to the node n at time t+1, and P_{dch,ωn}^{t+1} is the discharging power of TMCS ω to the node n at time t+1; P_{ch,ω}^{max} is the maximum charging power of TMCS ω, P_{dch,ω}^{max} is the maximum discharging power of TMCS ω; P_{out,n}^{t,max} is the maximum outflow power of the node n at the time t determined by the network limitation of a distribution network, and P_{inj,n}^{t,max} is the maximum injection power of the node n at the time t determined by the network limitation of the distribution network; P_{cs,ω}^{max} is the maximum power of TMCS ω charging service; I^{t ch,ω} and I^{t dch,ω} are binary variables, when TMCS ω is charged at time t, I^{t ch,ω}=1, when TMCS ω is not charged at time t, I^{t ch,ω}=0, when TMCS ω is discharged at time t, I^{t dch,ω}=1, when TMCS ω is not discharged at time t, I^{t dch,ω}=0; E_{ω}^{tmc} is the capacity of TMCS; ρ^{c} represents the charging demand satisfaction rate of the electric vehicle, which reflects the preference of CFO on the charging service quality; η_{ch,ω} is the charging efficiency of TMCS, η_{dch,ω} is the discharging efficiency of TMCS; SOC_{ω} is the SOC of TMCS ω at the end of time t, SOCₘₐₓ is the maximum SOC value of TMCS, and SOCₘᵢₙ is the minimum SOC value of TMCS.

The constraint formulas (16) to (19) establish a feasible set of charging/discharging power of TMCS ω in the arbitrage state. The constraint formula (20) defines the charge/discharge constraints associated with the TMCS arbitrage operation mode. The formula (21) is the TMCS charging service constraint. Finally, formula (22) and formula (23) are SOC constraints, and constraint formula (22) determines the SOC of TMCS ω at the end of time t.

### III. Day-Ahead Scheduling Model and Solution

TMCS is invested and operated by CFO, so that the goal of the day-ahead scheduling model of TMCS is to maximize the profitability of CFO, which is equal to daily operating revenue R(xₜ) minus operating and maintenance (O&M) costs C^{OM}(xₜ) and battery degradation costs C^{DEG}(xₜ), as shown in formula (24):

[symbol]

f(xₜ)=R(xₜ)−C^{OM}(xₜ)−C^{DEG}(xₜ), where xₜ=[P_{dch,ωm}^{t}, P_{dch,ωn}^{t}, P_{ch,ω}^{t},

$${x}_{i} = [ {P}_{dch , ω m}^{t} , {P}_{dch , ω n}^{t} , {P}_{ch , ω m}^{t} , {ζ}_{ω , nv}^{t} , {ζ}_{ω , mu}^{t} , {ζ}_{ω , mn}^{t} , {I}_{ch , ω}^{t} , {I}_{dch , ω}^{t} ∀ ω ∈ Ω , \{ m , u \} ∈ {M}_{c} , \{ n , v \} ∈ {M}_{a} , t ∈ T ] \qquad ( 24 )$$

$$R ( {x}_{t} ) = {\sum }_{t ∈ T} {\sum }_{ω ∈ Ω} ( {α}_{m}^{tmc} {P}_{dch , ω m}^{t} + {λ}_{n}^{t} {P}_{dch , ω n}^{t} - {λ}_{n}^{t} {P}_{ch , ω n}^{t} ) \qquad ( 25 )$$

$${C}^{OM} ( {x}_{t} ) = {\sum }_{ω ∈ Ω} ( {λ}_{n}^{0} {c}_{e}^{tmc} {d}_{mn , ω} + {𝒸}^{LA} + {𝒸}^{MT} ) \qquad ( 26 )$$

$${C}^{DEG} ( {x}_{t} ) = {𝒸}^{MDC} \{ {q}_{t} + {\sum }_{t ∈ T} {\sum }_{ω ∈ Ω} ( {P}_{dch , ω m}^{t} + {P}_{dch , ω n}^{t} + {P}_{ch , ω n}^{t} ) \} / {( 1 + {r}_{0} )}^{- κ ( t )} \qquad ( 27 )$$

$$\begin{matrix}s . t . & ( 6 ) - ( 15 ) & , & ( 16 - 23 )\end{matrix} \qquad ( 28 )$$

wherein [symbol] f(x) is the maximization of the profitability of CFO, R(xₜ) is daily operating revenue, C^{OM}(xₜ) is the daily operating and maintenance cost, and C^{DEG}(xₜ) is the daily battery degradation cost; and
the vector xₜ is a decision variable, λₙ^{t} is the time-of-use electricity price of the node n, λ⁰ₙ is the electricity price when the TMCS returns to a depot for charging after the service ends, cₑ^{tmc} is the energy consumption per kilometer of TMCS, d_{mn,ω} is the total travel of TMCS in one day, αₘ^{tmc} is the charging service fee of TMCS, c^{LA} is the daily labor cost, c^{MT} is the daily maintenance cost, c^{MDC} is the marginal degradation cost of the TMCS life cycle, qₜ is the calendar degradation parameter of the TMCS battery pack, r₀ is the discount rate; and κ(t) is the year number corresponding to the time t when the TMCS is put into use.

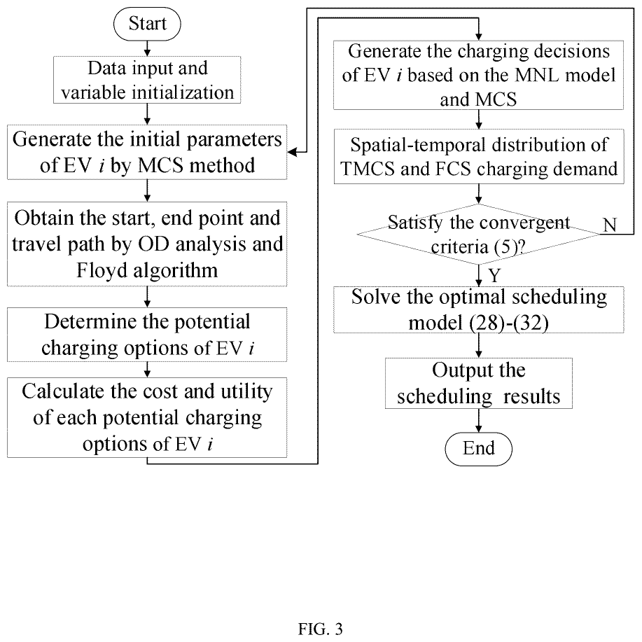

As the MILP model, the formula (24) to formula (28) can be solved with a commercial solver. The coordinated scheduling model of TMCS is coded using the YALMIP toolbox in the MATLAB environment and solved using Gurobi 10.0.1. The flowchart is shown in FIG. 3.

### IV. Embodiment

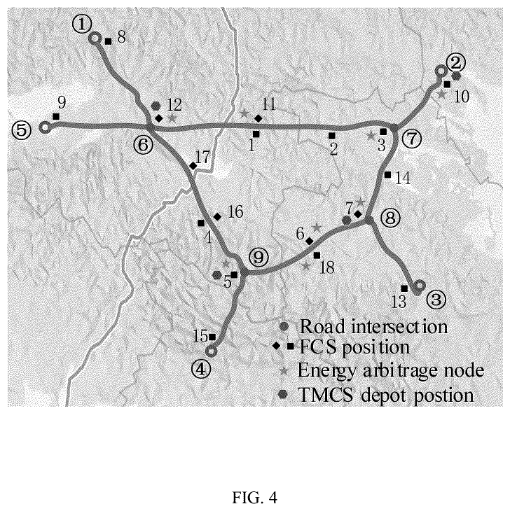

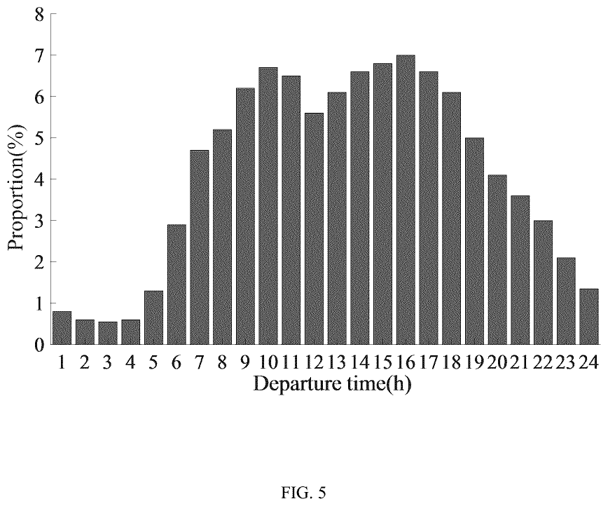

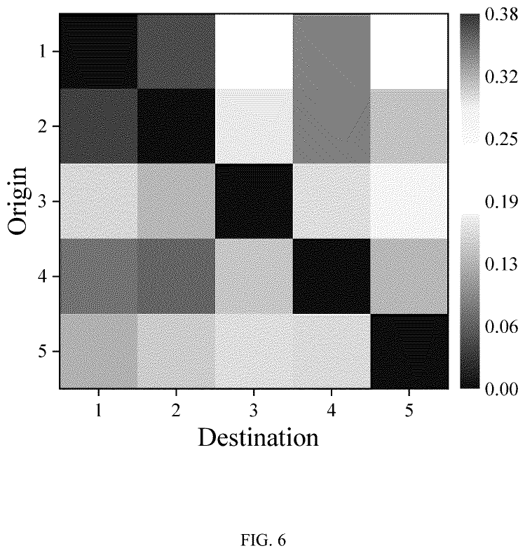

The embodiment of the present disclosure performs verification using the ring highway network of reference (as shown in FIG. 4). The highway network has 5 entrances and exits with a total mileage of 465 km. Among them, 1, 2, and 4 represent the entrances and exits of large cities, while 3 and 5 represent the entrances and exits of small cities. This topological structure is typical in modern metropolises. Four representative EV models on the market and battery parameters thereof are used (as shown in Table 1 and Table 2), and distribution of EV departure time tₛ and OD matrix are shown in FIG. 5 and FIG. 6. The travel parameters of the electric vehicle are shown in Table 3. The CFO operates 18 FCSs, whose positions are shown in FIG. 4, and the number of charging piles at stations is shown in Table 4. Assuming that the CFO has 4 TMCSs in total, the CFO is composed of Tesla Semi and Powerpack and is provided with 12 charging piles, and the service radius of the CFO is 50 km. After completing a day of operation, the TMCS will return to the respective depot. The position of the grid arbitrage node is shown in FIG. 4, and the load electricity price adopts the typical domestic time-of-use electricity price. Other parameters are shown in Table 5.

TABLE 1
Distribution of EV battery capacity

| | EV type | | | | | | | |
|---|---|---|---|---|---|---|---|---|
| | L7e | | M1 | | N1 | | N2 | |
| Distribution law | Gamma | | Gamma | | Normal | | Normal | |
| Proportio | 10 | | 50 | | 20 | | 20 | |
| Parameter | θ^{c} | = 10.8 | θ^{c} | = 4.5 | μ^{c} | = 43.0 | μ^{c} | = 85.3 |
| | ν^{c} | = 0.8 | ν^{c} | = 6.7 | σ^{c} | = 9.5 | σ^{c} | = 28.0 |

| | | | | |
|---|---|---|---|---|
| m [symbol] _{,min} (kWh) | 15.0 | 10.0 | 29.6 | 51.0 |
| m_{r,max} (kWh) | 65.0 | 72.0 | 60.0 | 120.0 |

Where θ^{c} is the shape parameter; ν^{c} is the scale parameter; μ^{c} is the average battery capacity; and σ^{c} is the standard deviation of the battery capacity [symbol]
indicates data missing or illegible when filed

TABLE 2
Distribution of energy consumption per unit mileage of EV

| Cₑ (kWh/km)/EV | | | | |
|---|---|---|---|---|
| type | L7e | M1 | N1 | N2 |
| 0.05-0.10 | 0.34 | 0.05 | 0.00 | 0.00 |
| 0.10-0.15 | 0.58 | 0.35 | 0.29 | 0.00 |
| 0.15-0.20 | 0.08 | 0.45 | 0.14 | 0.00 |
| 0.20-0.25 | 0.00 | 0.15 | 0.57 | 0.00 |
| 0.45-0.50 | 0.00 | 0.00 | 0.00 | 0.50 |
| 0.50-0.55 | 0.00 | 0.00 | 0.00 | 0.25 |
| 0.80-0.85 | 0.00 | 0.00 | 0.00 | 0.25 |

TABLE 3
Distribution of travel parameters of EVs

| | Station | | | | | |
|---|---|---|---|---|---|---|
| | SOC^{st} | | M_{ci} | | dᵢ^{re} | |
| Distribution law | Normal | | Normal | | Normal | |
| | distribution | | distribution | | distribution | |
| Distribution | μ^{d} | = 0.85 | μ^{d} | = 0.7 | μ^{d} | = 35 |
| parameter | σ^{d} | = 0.1 | σ^{d} | = 0.2 | σ^{d} | = 12.6 |

| | | | |
|---|---|---|---|
| Minimum value | 0.6 | 0.6 | 5 |
| Maximum value | 0.95 | 0.82 | 60 |

TABLE 4
Number of charging piles of FCSs

| Station | Charging pile | Station | Charging pile | Station | Charging pile |
|---|---|---|---|---|---|
| 1 | 14 | 7 | 12 | 13 | 9 |
| 2 | 13 | 8 | 9 | 14 | 18 |
| 3 | 12 | 9 | 10 | 15 | 16 |
| 4 | 21 | 10 | 8 | 16 | 22 |
| 5 | 17 | 11 | 20 | 17 | 23 |
| 6 | 18 | 12 | 22 | 18 | 23 |

According to the EV penetration rate in the Beijing-Tianjin-Hebei region of China in 2022, it is estimated that an average of 25,000 EVs will be traveling on the ring road network on the weekday. The following two scenarios are constructed, and the optimization scheduling results of the embodiment of the present disclosure are compared.

Scenario 1: based on the traffic flow of the weekday, the TMCS only participating in EV charging service (Case 1) and the coordinated optimization scheduling method for TMCS proposed in the present disclosure (Case 2) are compared.

Scenario 2: Based on holiday traffic flow (about twice the weekday traffic volume), the above two scenarios are also compared.

TABLE 5
Other simulation parameters

| Variable | Value | Unit | Variable | Value | Unit | Variable | Value | Unit |
|---|---|---|---|---|---|---|---|---|
| [symbol] | 3 | ¥/kWh | SOCₘₐₓ | 0.9 | / | r [symbol] | 5 | % |
| [symbol] | 1.5 | ¥/kWh | SOCₘᵢₙ | 0.15 | / | [symbol] ^{MDC} | 50 | $/MWh |
| ε | 100 | kW | [symbol] | 20 | / | [symbol] | 0.1 | Hour |
| [symbol] | 800 | kW | η [symbol] | 0.9 | / | [symbol] | 176 | Hour |
| [symbol] | 3000 | kWh | η [symbol] | 0.9 | / | [symbol] | 90 | kW |
| [symbol] | 1.25 | kwh/km | η [symbol] | 0.9 | / | [symbol] | 500 | kW |
| [symbol] ^{LA} | 200 | ¥/day | η [symbol] | 0.9 | / | [symbol] | 200 | kW |
| [symbol] ^{MT} | 30 | ¥/day | [symbol] | 23 | / | [symbol] | 6.3 | ¥/$ |
| [symbol] | 1000 | kWh/day | [symbol] | 1 | / | | | |

[symbol]

indicates data missing or illegible when filed

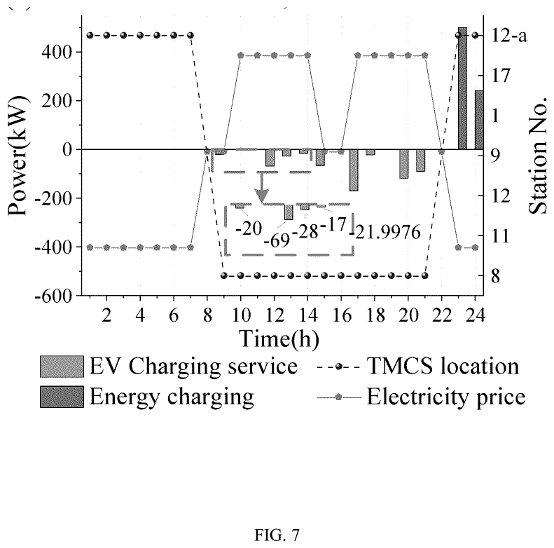

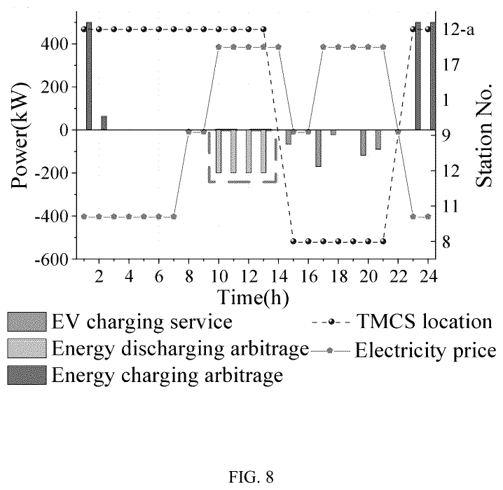

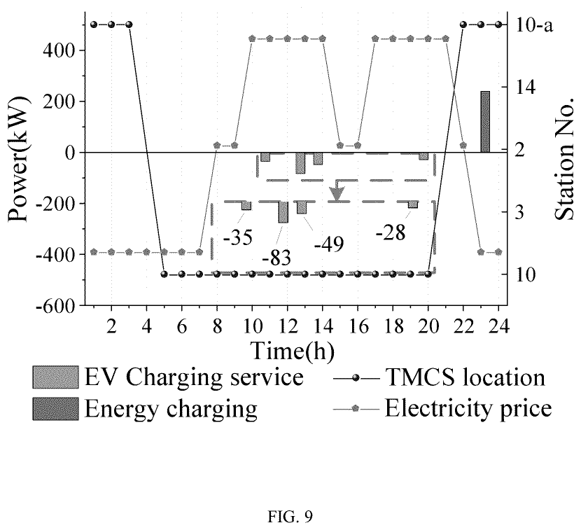

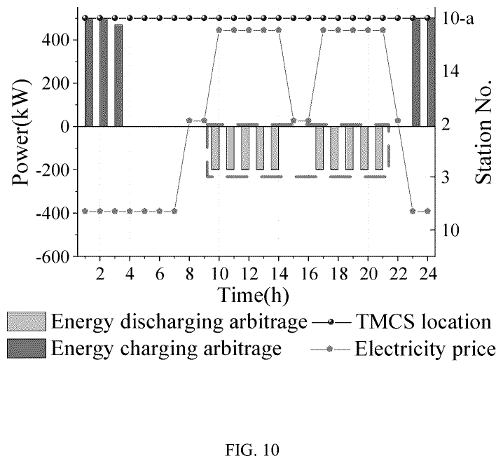

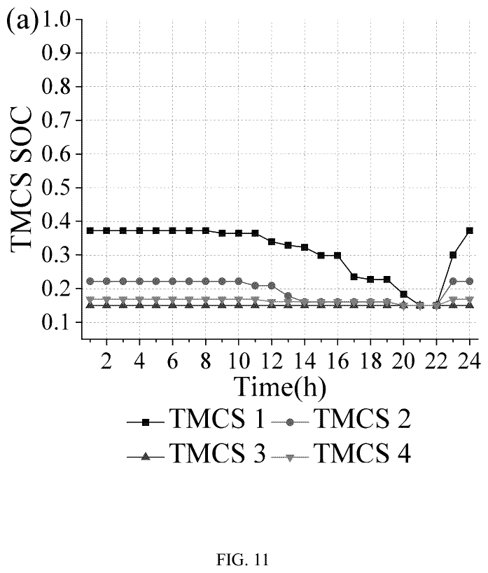

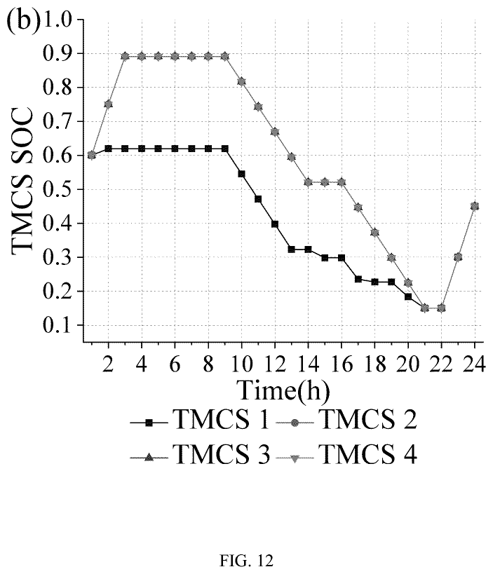

The operation optimization results obtained in the Scenario 1 are shown in FIGS. 7 to 12. In FIGS. 7 to 10, a positive power indicates that the TMCS is in a charging state, and a negative power indicates that the TMCS is in a discharging state, and in FIGS. 7 to 8, the vertical coordinate “12-a” represents the grid arbitrage node 12. It can be seen that a large-capacity TMCS configured by CFO to meet the peak charging load demand in Scenario 2 has a very low utilization rate in Scenario 1, Case 1. As shown in FIGS. 7 and 9, TMCS 1 and TMCS 2 have only a small EV charging load, while TMCS 3 and TMCS 4 are almost idle. As shown in FIGS. 8 and 10, in Case 2, TMCS 1 and TMCS 2 give up EV charging loads of 134 kW and 195 kW, respectively, and participate in grid energy arbitrage. TMCS 3 and TMCS 4 operate in the same manner as TMCS 2. As can be seen from FIGS. 11 to 12, the TMCS has a very low utilization rate in Case 1, which is neither economical nor will have an impact on the service life of the equipment, whereas Case 2 significantly improves the utilization rate of the TMCS.

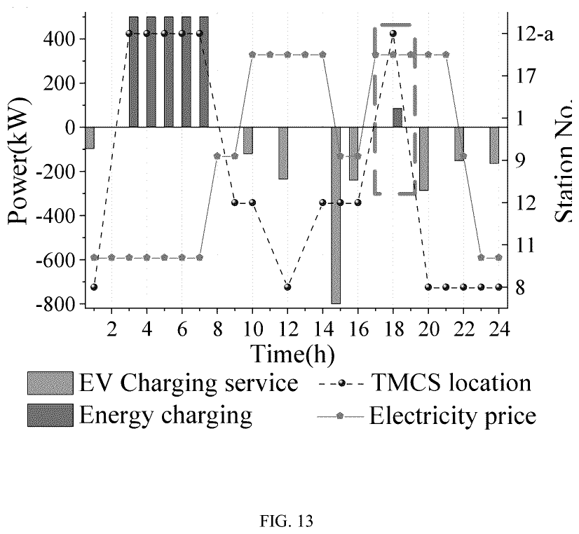

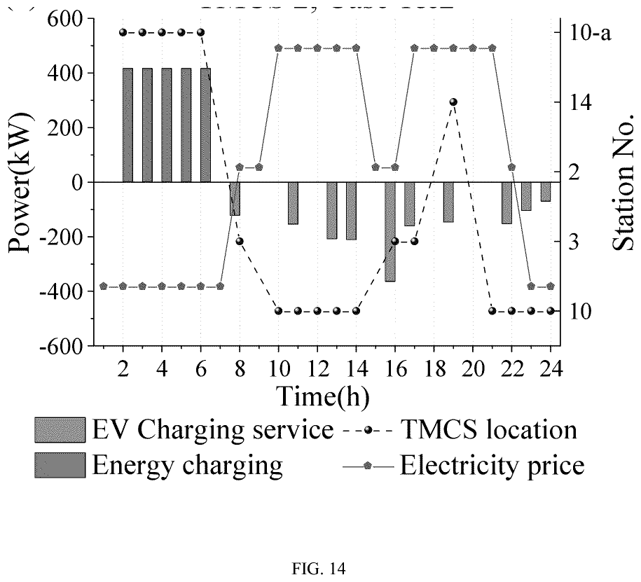

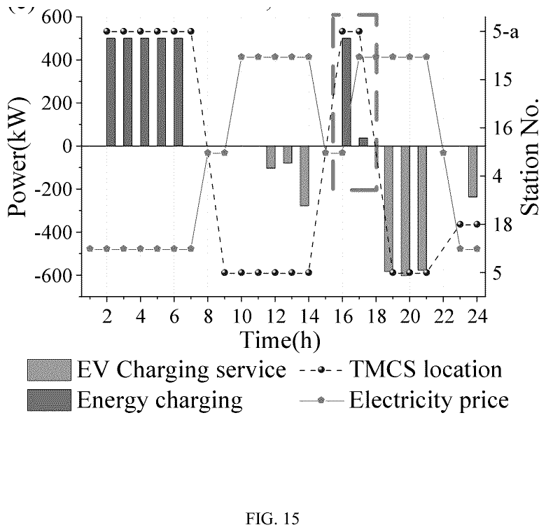

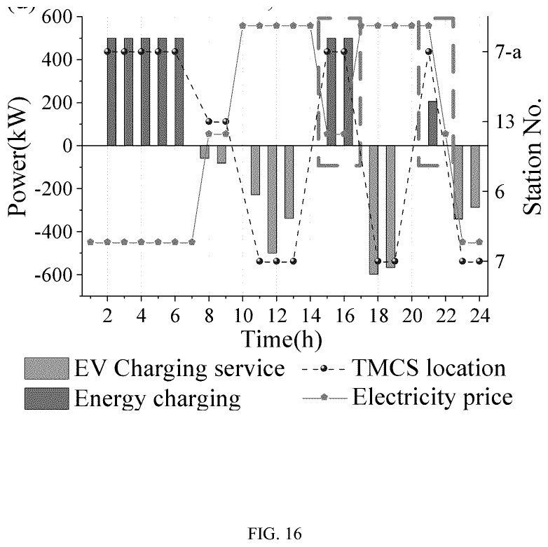

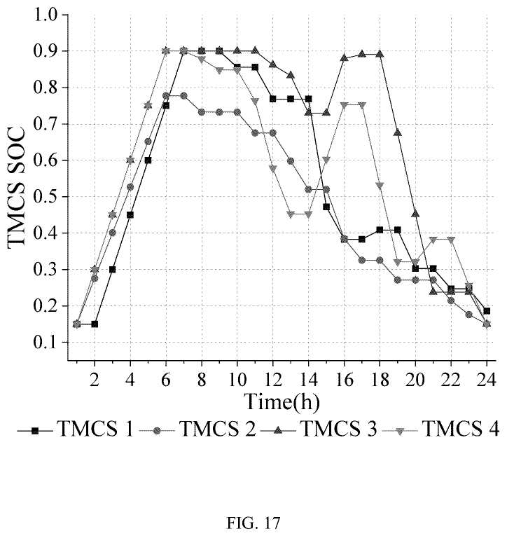

The operation optimization results obtained in Scenario 2 are shown in FIGS. 13 to 17. Due to the increase in traffic flow during holidays, the charging demand of TMCS increases significantly. Therefore, TMCS in Case 2 operates in the same manner as in Case 1 and does not participate in energy arbitrage. The TMCS 1 is taken as an example to illustrate the scheduling process. The TMCS 1 stays at depot node 12 for 8 hours (03:00-11:00) and is charged at (03:00-08:00). Subsequently, the TMCS 1 switches to EV charging service mode at (08:00-09:00) and is discharged for 1 hour (10:00-11:00). Then, the TMCS 1 moves from node 12 to node 8 and is discharged for 1 hour (12:00-13:00), and then moves from node 8 to node 12 and is discharged for 2 hours (15:00-17:00). Next, the TMCS 1 switches to energy arbitrage mode and is charged at (17:00-18:00). Then, the TMCS 1 returns to node 8 and is discharged to provide EV charging service (20:00-02:00). Finally, the TMCS 1 returns to the depot node 12 and is charged at (02:00-03:00). It can be seen that the TMCS is transferred among different stations for multiple times, the station with the largest charging demand in the service radius at the same time is selected to provide the EV charging service, and the TMCS returns to a depot after the completing service in one day and is charged in a low-electricity-price period. It is noted that the quantity charged by the TMCS is only enough to meet its discharge demand to reduce the charging and battery degradation costs, as shown in FIGS. 13, 14 and 16. In addition, to meet peak charging demands in the afternoon and evening, TMCS preferentially selects flat electricity prices (15:00-17:00) for charging operations of corresponding electricity quantity during the idle period in the noon.

To better analyze the operating of TMCS, the EV charge demand loss rate ρ and the TMCS capacity utilization rate δ are defined as shown in formulas (29) and (30), respectively. Tables 6 and 7 give the comparison of profitability and key operation indicators under the two scenarios, respectively. E_{d}^{tmc}, E_{c}^{tmc}, and Etₐ^{tmc} are the EV charging demand of TMCS, the EV charging load satisfied by TMCS, and the arbitrage discharge capacity, respectively.

$$ρ = ( 1 - {\sum }_{t ∈ T} {\sum }_{ω ∈ Ω} {P}_{dch , ω m}^{t} / {\sum }_{t ∈ T} {P}_{m}^{t} ) \times 100 \% , ∀ m ∈ {M}_{c} \qquad ( 29 )$$

$$δ = \frac{{\sum }_{t ∈ T} {\sum }_{ω ∈ Ω} ( {P}_{dch , ω m}^{t} + {P}_{dch , ω n}^{t} )}{{\sum }_{ω ∈ Ω} {E}_{ω}^{tmc} ( {SOC}_{max} - {SOC}_{min} )} \times 100 \% , ∀ m ∈ {M}_{c} , n ∈ {M}_{a} \qquad ( 30 )$$

TABLE 6
Comparison of TMCS profits

| | | R (xₜ) | C^{OM} (xₜ) | C^{DEG} (xₜ) | Profit |
|---|---|---|---|---|---|
| Scenario | Mode | (¥10³) | (¥10³) | (¥10³) | (¥10³) |
| Scenario 1 | Case 1 | 2.31 | 1.1 | 1.01 | 0.2 |
| | Case 2 | 8.88 | 0.98 | 5.75 | 2.15 |
| Scenario 2 | Case 1 | 21.88 | 1.64 | 7.17 | 13.08 |
| | Case 2 | 21.88 | 1.64 | 7.17 | 13.08 |

TABLE 7
Comparison of TMCS operation parameters

| Variable | Scenario 1 | Scenario 2 |
|---|---|---|
| E_{d}^{tmc} (kWh) | 971 | 12520 |
| E_{c}^{tmc} (kWh) | Case 1: 921 | Case 1: 9248 |
| | Case 2: 537 | Case 2: 9248 |
| Eₐ^{tmc} (kWh) | Case 1: 0 | Case 1: 0 |
| | Case 2: 6800 | Case 2: 0 |
| ρ (%) | Case 1: 5.15 | Case 1: 26.13 |
| | Case 2: 44.7 | Case 2: 26.13 |
| δ (%) | Case 1: 10.23 | Case 1: 102.76 |
| | Case 2: 81.52 | Case 2: 102.76 |

As can be seen from Table 6 that the EV charging demand is small in Scenario 1, Case 1, TMCS is difficult to make profits, and the capacity utilization rate 8 of TMCS is only 10.23%. Case 2 solves the idling of TMCS at low EV charging demand (δ=81.52%) by participating in grid energy arbitrage and increases the profitability of CFO significantly (2150 yuan/day). Since the EV charging demand increases greatly, TMCS provides only the EV charging service in Scenario 2, Case 2, and thus the profitability of CFO is the same as that in Case 1. It is noted that since the TMCS operation time is longer during holidays, it can be considered that c^{LA} will be doubled.

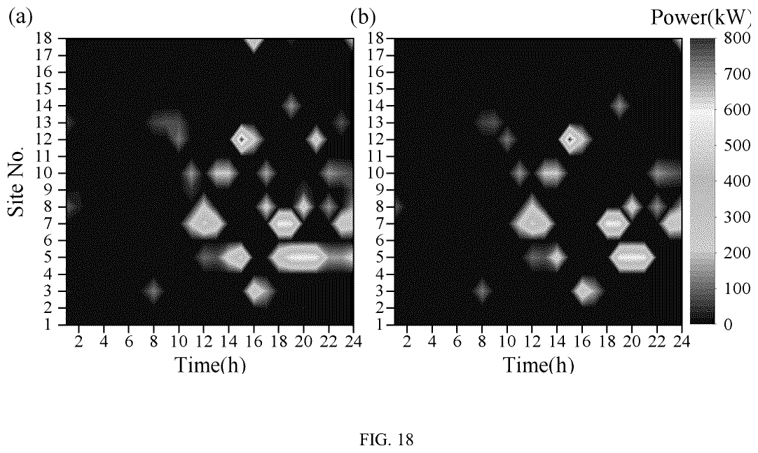

It can be seen that the coordinated scheduling model proposed in the present disclosure improves the profitability and δ of TMCS by 10.75 times and 71.29% respectively under the weekday traffic flow in Scenario 1. The abandoned EV charging demand in Scenario 1, Case 2 is about 384 kW, and these users will choose FCS charging. In addition, as shown in FIG. 18, in Scenario 2, 26.13% of the charging demand is still not served by TMCS, because there are large charging demands at multiple stations at the same time. The δ greater than 100% indicates that the TMCS is charged and discharged multiple times within one day. It can be seen that the expansion of FCS and TMCS can be comprehensively considered according to the ρ and δ values in Scenarios 1 and 2.

Unless otherwise specified, the models of the devices in the embodiments of the present disclosure are not limited, and any device that can perform the above functions may be used.

The technical features of the foregoing embodiments may be combined randomly. For brevity of description, not all possible combinations of the technical features in the foregoing embodiments are listed. However, provided no conflict occurs when the technical features are combined, it should be considered that the technical features fall within the scope of the disclosure of this specification.

Various changes and modifications can be made by those of ordinary skills in the art without departing from the protection scope of the present disclosure, and these changes and modifications are all within the scope of the present disclosure. The protection scope of the present disclosure shall be subject to the claims.

What is claimed is:

1. A day-ahead coordinated optimization scheduling method for a truck mobile charging station (TMCS), comprising:
S1: constructing an electric vehicle (EV) model, and generating spatial-temporal distribution of EV charging demands for a fixed charging station (FCS) and the TMCS by using the EV model according to traffic flow prediction data and configuration information of the FCS and the TMCS; and
S2: constructing a TMCS scheduling model, wherein the TMCS scheduling model describes spatial-temporal dynamic characteristics of TMCS operation and completes coordinated optimization scheduling of TMCS between EV charging service and energy arbitrage, and establishing a day-ahead optimization scheduling method for TMCS to maximize the profitability of a charging facility operator (CFO);
in the step S1, the market share and energy consumption characteristics of different types of EVs are obtained according to market sales data, wherein the energy consumption characteristics of EVs comprise battery capacity and probability distribution of energy consumption per unit mileage;
a departure time and a probability density function of initial values of state of charge (SOC) of the EVs under unified confidence are obtained by fitting EV charging;
start and end points of the EV are generated by an origin-destination (OD) analysis method, and a travel path is obtained based on Monte Carlo simulation and a Floyd algorithm;
EVi needs to be charged on the way, and potential charging selection solutions are generated according to road and travel limits, SOC data and charging station positions, wherein a set of the charging selection solutions is denoted as Sᵢ, Sᵢ comprises J solutions, and EVi is an i^{th} electric vehicle;
the EV model is as follows:
a charging capacity when EVi selects the charging solution j is shown in formula (1):
$${ℳ}_{i}^{m , j} = \{ \begin{matrix}η \text{?} 𝒞 \text{?} ( {d}_{i} + {d}_{i}^{re} - {d}_{i}^{m} ) , & if 0 < η \text{?} 𝒞 \text{?} ( {d}_{i} + {d}_{i}^{re} - {d}_{i}^{m} ) / ℳ \text{?} \leq 0.9 \\ {𝕄}_{i}^{m , j} , & if η \text{?} 𝒞 \text{?} ( {d}_{i} + {d}_{i}^{re} - {d}_{i}^{m} ) / ℳ \text{?} > 0.9\end{matrix} \qquad ( 1 )$$
$$\text{?} \text{indicates text missing or illegible when filed}$$
wherein [symbol] is the charging capacity of the EVi when the solution j is selected at a road network node m, ηₗᵢ is a battery energy efficiency coefficient, Cₑᵢ is the energy consumption per unit mileage of the EVi, dᵢ is the remaining mileage of the EVi, dᵢ^{re} is the remaining available mileage of the EVi based on user preference, dᵢ^{m} is the mileage when the EVi reaches the node m, [symbol] ᵣᵢ is a rated capacity of a battery of the EVi, [symbol] is the charging capacity of the EVi obtained by MCS sampling, and dᵢ^{re} and [symbol] satisfies truncated normal distribution;
the cost when EVi selects the charging solution j is the sum of charging cost and time cost, as shown in formula (2):
$${c}_{i} ( j ) = {α}_{m}^{j} {ℳ}_{i}^{m , j} + {INC}_{i} ( {W}_{q}^{j , t} + {ℳ}_{i}^{m , j} / {η}_{dch} {P}_{r}^{j} + {s}_{c} ) / {T}_{m} \qquad ( 2 )$$
wherein cᵢ(j) is the total cost when EVi selects the solution j, αₘ^{j} is the charging fee per kWh of the solution j; INCᵢ is the monthly income of the user, W_{q}^{j,t} is the queuing time of the solution j at time t determined by the M/M/c/∞/∞ queuing theory, [symbol] _{dch} is the charging efficiency, Pᵣ^{j} is the rated power of a charging pile, S_{c} is the operation time, and Tₘ is the average monthly working time of the user;
the probability of EVi selecting the solution j is shown in formula (3), and the TMCS charging demand at node m at time t is generated by formula (4);
$${𝒫}_{i} ( j ) = exp ( {c}_{i} ( j ) ) / {\sum }_{j}^{J} exp ( {c}_{i} ( j ) ) \qquad ( 3 )$$
$${P}_{m}^{t} = {\sum }_{i} {ℳ}_{i}^{m , j} , i ∈ {χ}_{t , m}^{tmc} \qquad ( 4 )$$
wherein [symbol] ᵢ(j) is the probability that a driver chooses the charging scheme j, Pₘ^{t} is the hourly EV charging demand of TMCS at node m, and χ_{t,m}^{tmc} is the set of the EVs selecting TMCS charging;
the simulation ends when a convergence condition of formula (5) is met, and the spatial-temporal distribution of the EV charging demand is obtained:
$$max [ \vert ( {\sum }_{π = 1}^{Π} {P}_{m , π}^{t} - {\sum }_{π = Π}^{2 Π} {P}_{m , π}^{t} ) / Π \vert ] \leq ε \qquad ( 5 )$$
wherein P_{m,π}^{t} is the hourly EV charging demand at node m after a π^{th} iteration, Π is a predefined number, and ε is the convergence coefficient;
in the step S2, a set M of TMCS operation positions is divided into two disjoint subsets, M_{c} and Mₐ, wherein M_{c} represents a set of charging service nodes, Mₐ represents a set of arbitrage nodes, and a virtual arc represented by the TMCS start and end points describes the dynamic operation state of the TMCS, so as to obtain the spatial-temporal distribution characteristics of the TMCS;
the virtual arc is divided into a transit arc and a parking arc, the transit arc is composed of two nodes and connecting arcs, the transit arc represents a feasible transit route, the transit arc has a directionality and is divided into a charging transit arc Z_{c}, an arbitrage transit arc Zₐ and a transfer arc Zₑ according to node types, and the parking arc represents that TMCS stops at a certain node for at least one time period;
the TMCS scheduling model is as follows:
$$\text{?} {ζ}_{ω , mu}^{t} + \text{?} {ζ}_{ω , nv}^{t} + {ζ}_{ω , mn}^{t} = 1 , \begin{matrix}∀ ω ∈ Ω , & t ∈ T\end{matrix} \qquad ( 6 )$$
$$\text{?} {ζ}_{ω , mu}^{t} + \text{?} {ζ}_{ω , mn}^{t} \geq {ζ}_{ω , mn}^{t + 1} - {ζ}_{ω , mn}^{t} , \qquad ( 7 )$$
$$∀ ω ∈ Ω , m ∈ {M}_{c} , n ∈ M \text{?} , t ∈ T$$
$$\text{?} {ζ}_{ω , nv}^{t} + \text{?} {ζ}_{ω , mn}^{t} \geq {ζ}_{ω , mn}^{t + 1} - {ζ}_{ω , mn}^{t} , \qquad ( 8 )$$
$$∀ ω ∈ Ω , m ∈ {M}_{c} , n ∈ M \text{?} , t ∈ T$$
$$\text{?} + \text{?} = \text{?} + \text{?} , ∀ ω ∈ Ω , m ∈ {M}_{c} , n ∈ M \text{?} , t ∈ T \qquad ( 9 )$$
$$\text{?} + \text{?} = \text{?} + \text{?} , \qquad ( 10 )$$
$$∀ ω ∈ Ω , m ∈ {M}_{c} , n ∈ M \text{?} , t ∈ T$$
$$\text{?} + \text{?} = \text{?} , \qquad ( 11 )$$
$$∀ ω ∈ Ω , m ∈ {M}_{c} , n ∈ M \text{?}$$
$$\text{?} + \text{?} = \text{?} , ∀ ω ∈ Ω , m ∈ {M}_{c} , n ∈ M \text{?} \qquad ( 12 )$$
$${ζ}_{ω , mu}^{t} + {ζ}_{ω , mu}^{t + 1} \leq 1 , ∀ ( m , u ) ∈ {Z}_{c} , m \neq u , t ∈ T \qquad ( 13 )$$
$${ζ}_{ω , mu}^{t} + {ζ}_{ω , mu}^{t + 1} \leq 1 , ∀ ( n , v ) ∈ {Z}_{a} , n \neq v , t ∈ T \qquad ( 14 )$$
$${ζ}_{ω , mu}^{t} + {ζ}_{ω , mu}^{t + 1} \leq 1 , ∀ ( m , n ) ∈ {Z}_{e} , m \neq n , t ∈ T \qquad ( 15 )$$
$$\text{?} \text{indicates text missing or illegible when filed}$$
wherein ω is the number of TMCS, Ω is the set of TMCS, T is the set of hourly periods t, m and u are road network charging service nodes, n and v are energy arbitrage nodes, ζ_{ω,mu}^{t}, ζ_{ω,nv}^{t}, ζ_{ω,mn}^{t}, ζ_{ω,mm}^{t}, ζ_{ω,nn}^{t}, ζ_{ω,um}^{t}, ζ_{ω,nm}^{t}, ζ_{ω,vn}^{t}, ζ_{ω,mm}^{t+1}, ζ_{ω,nn}^{t+1}, ζ_{ω,mu}^{t+1}, ζ_{ω,mm}^{t+1}, ζ_{ω,nv}^{t+1}, ζ_{ω,nv}^{t}^{ₑ}⁺¹, ζ_{ω,nm}^{t+1}, ζ_{ω,nm}^{t}^{ₑ}⁺¹, ζ_{ω,nn}^{t}^{ₑ}, ζ_{ω,vn}^{t}^{ₑ}⁻¹, ζ_{ω,mn}^{t}^{ₑ}⁻¹, ζ_{ω,um}^{t+1}, ζ_{ω,vn}^{t+1}, and ζ_{ω,nm}^{t+1} are binary variables, and represent whether the TMCS numbered ω is on the corresponding transit arc at the corresponding time;
when the TMCS ω is on the transit arc (m, u) at the time t, ζ_{ω,nm}^{t}=1, and when the TMCS ω is not on the transit arc (m, u), ζ_{ω,mu}^{t}=0, and the same is true for other binary variables; tₑ is the time for ending the work of the TMCS; and
Z₊_{_{c}} represents a forward-direction charging arc, Z₋_{^{e}} represents a reverse-direction charging arc, Z₊_{ₐ}, represents a forward-direction arbitrage arc, Z₋_{^{a}} represents a reverse-direction arbitrage arc, Z₊_{ₑ} represents a forward-direction transfer arc, and Z₋ₑ represents a reverse-direction transfer arc.

2. The day-ahead coordinated optimization scheduling method for the TMCS of claim 1, wherein TMCS is required to satisfy the following operating constraints during charging and arbitrage operations:
$$0 \leq {P}_{ch , ω n}^{t} \leq {\sum }_{n ∈ {M}_{a}} {ζ}_{ω , nn}^{t} min ( {P}_{c h , ω}^{max} , {P}_{o u t , n}^{t , max} ) \qquad ( 16 )$$
$$0 \leq {P}_{ch , ω n}^{t} \leq {I}_{ch , ω}^{t} min ( {P}_{ch , ω}^{max} , {P}_{o u t , n}^{t , max} ) \qquad ( 17 )$$
$$\{ \begin{matrix}\begin{matrix}0 \leq {P}_{dch , ω n}^{t} \leq {\sum }_{n ∈ {M}_{a}} {ζ}_{ω , nn}^{t} min ( {P}_{dch , ω}^{max} , {P}_{inj , n}^{t , max} ) , & if {P}_{m}^{t} \leq {ρ}^{c} {P}_{cs , ω}^{max}\end{matrix} \\ \begin{matrix}{P}_{dch , ω n}^{t} = 0 , & otherwise\end{matrix}\end{matrix} \qquad ( 18 )$$
$$\{ \begin{matrix}\begin{matrix}0 \leq {P}_{dch , ω n}^{t} \leq {I}_{dch , ω}^{t} min ( {P}_{dch , ω}^{max} , {P}_{inj , n}^{t , max} ) , & if {P}_{m}^{t} \leq {ρ}^{c} {P}_{cs , ω}^{max}\end{matrix} \\ \begin{matrix}{P}_{dch , ω n}^{t} = 0 , & otherwise\end{matrix}\end{matrix} \qquad ( 19 )$$
$${I}_{c h , ω}^{t} + {I}_{d c h , ω}^{t} \leq {\sum }_{n ∈ {M}_{a}} {ζ}_{ω , nn}^{t} \qquad ( 20 )$$
$${P}_{dch , ω m}^{t} = {ζ}_{ω , m m}^{t} min ( {P}_{m}^{t} , {P}_{cs , ω}^{max} ) \qquad ( 21 )$$
$${SOC}_{ω}^{i + 1} = {SOC}_{ω}^{i} - \frac{Δ T}{{E}_{ω}^{\text{?}}} \{ ( {\sum }_{n ∈ {M}_{a}} {P}_{dch , ω n}^{i + 1} + {\sum }_{n ∈ {M}_{a}} {P}_{dch , ω m}^{i + 1} ) / {η}_{dch , ω} - {η}_{ch , ω} {\sum }_{n ∈ {M}_{a}} {P}_{ch , ω n}^{i + 1} \} , ∀ ω ∈ Ω , t ∈ T \qquad ( 22 )$$
$${SOC}_{min} \leq S O {C}_{ω}^{t} \leq {SOC}_{max} , ∀ ω ∈ Ω , t ∈ T \qquad ( 23 )$$
$$\text{?} \text{indicates text missing or illegible when filed}$$
wherein P_{ch,ωn}^{t} is the charging power of TMCS ω to the node n at time t, P_{dch,ωn}^{t} is the discharging power of TMCS ω to the node n at time t, P_{ch,ωn}^{t+1} is the charging power of TMCS ω to the node n at time t+1, and P_{dch,ωn}^{t+1} is the discharging power of TMCS ω to the node n at time t+1; P_{ch,ωn}^{max} is the maximum charging power of TMCS ω, P_{dch,ω}^{max} is the maximum discharging power of TMCS ω; P_{out,n}^{t,max} is the maximum outflow power of the node n at the time t determined by the network limitation of a distribution network, and P_{inj,n}^{t,max} is the maximum injection power of the node n at the time t determined by the network limitation of the distribution network; P_{cs,ω}^{max} is the maximum power of TMCS ω charging service; I^{t ch,ω} and I^{t dch,ω} are binary variables, when TMCS ω is charged at time t, I^{t ch,ω}=1, when TMCS ω is not charged at time t, I^{t ch,ω}=0, when TMCS ω is discharged at time t, I^{t dch,ω}=1, when TMCS ω is not discharged at time t, I^{t dch,ω}=0; E_{ω}^{tmc} is the capacity of TMCS; ρ^{c} represents the charging demand satisfaction rate of the electric vehicle, which reflects the preference of CFO on the charging service quality; η_{ch,ω} is the charging efficiency of TMCS, η_{dch,ω} is the discharging efficiency of TMCS; SOC_{ω}, is the SOC of TMCS ω at the end of time t, SOCₘₐₓ is the maximum SOC value of TMCS, and SOCₘᵢₙ is the minimum SOC value of TMCS.

3. The day-ahead coordinated optimization scheduling method for the TMCS of claim 2, wherein a calculation method to maximize the profitability of CFO is as follows: [symbol]
f(xₜ)=R(xₜ)−C^{OM}(xₜ)−C^{DEG}(xₜ), where xₜ=P_{dch,ωm}^{t}, P_{dch,ωn}^{t}, P_{ch,ωn}^{t},
$${x}_{i} = [ {P}_{dch , ω m}^{t} , {P}_{dch , ω n}^{t} , {P}_{ch , ω m}^{t} , {ζ}_{ω , nv}^{t} , {ζ}_{ω , mu}^{t} , {ζ}_{ω , mn}^{t} , {I}_{ch , ω}^{t} , {I}_{dch , ω}^{t} ∀ ω ∈ Ω , \{ m , u \} ∈ {M}_{c} , \{ n , v \} ∈ {M}_{a} , t ∈ T ] \qquad ( 24 )$$
$$R ( {x}_{t} ) = {\sum }_{t ∈ T} {\sum }_{ω ∈ Ω} ( {α}_{m}^{tmc} {P}_{dch , ω m}^{t} + {λ}_{n}^{t} {P}_{dch , ω n}^{t} - {λ}_{n}^{t} {P}_{ch , ω n}^{t} ) \qquad ( 25 )$$
$${C}^{OM} ( {x}_{t} ) = {\sum }_{ω ∈ Ω} ( {λ}_{n}^{0} {c}_{e}^{tmc} {d}_{mn , ω} + {𝒸}^{LA} + {𝒸}^{MT} ) \qquad ( 26 )$$
$${C}^{DEG} ( {x}_{t} ) = {𝒸}^{MDC} \{ {q}_{t} + {\sum }_{t ∈ T} {\sum }_{ω ∈ Ω} ( {P}_{dch , ω m}^{t} + {P}_{dch , ω n}^{t} + {P}_{ch , ω n}^{t} ) \} / {( 1 + {r}_{0} )}^{- κ ( t )} \qquad ( 27 )$$
$$\begin{matrix}s . t . & ( 6 ) - ( 15 ) & , & ( 16 - 23 )\end{matrix} \qquad ( 28 )$$
wherein [symbol] f(xₜ) is the maximization of the profitability of CFO, (xₜ) is daily operating revenue, C^{OM}(xₜ) is the daily operating and maintenance cost, and C^{DEG}(xₜ) is the daily battery degradation cost; and
the vector xₜ is a decision variable, λₙ′ is the time-of-use electricity price of the node n, λ⁰ₙ is the electricity price when the TMCS returns to a depot for charging after the service ends, cₑ^{tmc} is the energy consumption per kilometer of TMCS, d_{mn,ω} is the total travel of TMCS in one day, αₘ^{tmc} is the charging service fee of TMCS, c^{LA} is the daily labor cost, c^{MT} is the daily maintenance cost, c^{MDC} is the marginal degradation cost of the TMCS life cycle, qₜ is the calendar degradation parameter of the TMCS battery pack, r₀ is the discount rate; and κ(t) is the year number corresponding to the time t when the TMCS is put into use.
